(19) United States
(12) Patent Application Publication
(10) Pub. No.: US 2026/0039332 A1
(43) Pub. Date: Feb. 5, 2026

(54) INFLUENCE OF RECONFIGURABLE INTELLIGENT SURFACE STATUS ON USER EQUIPMENT

(71) Applicant: QUALCOMM Incorporated, San Diego, CA (US)

(72) Inventors: Zhikun WU, Beijing (CN); Wanshi CHEN, San Diego, CA (US); Yu ZHANG, San Diego, CA (US); Hyojin LEE, San Diego, CA (US)

(21) Appl. No.: 19/100,868

(22) PCT Filed: Oct. 26, 2022
(86) PCT No.: PCT/CN2022/127548

§ 371 Date: Feb. 3, 2025

(51) Int. Cl. H04B 7/04; H04W 24/10; H04W 76/28

(52) U.S. Cl. CPC H04B 7/04013; H04W 24/10; H04W 76/28

(57) ABSTRACT

A state of a user equipment (UE) may depend on a state of a reconfigurable intelligent surface (RIS). The UE obtains a time pattern of a RIS that defines activation states of the RIS including at least an off-state and an on-state. The UE determines a state of the UE based at least in part on the time pattern of the RIS. The base station also determines the state of the UE and schedules communications with the UE when the UE is in an active state. The UE may measure channel conditions between the UE and a base station when the RIS is in at least the off-state and the on-state. The state of the UE may also be based in part on the channel conditions between the UE and the base station when the RIS is in at least the off-state and the on-state.

### TECHNICAL FIELD

The present disclosure relates to wireless communications, and more particularly to influence of reconfiguration intelligent surface (RIS) status on user equipment (UE).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

In some aspects, the techniques described herein relate to a method of wireless communication at a user equipment (UE). The method includes obtaining a time pattern of a reconfigurable intelligent surface (RIS) defining that defines activation states of the RIS including at least an off-state and an on-state. The method includes determining a state of the UE based at least in part on the time pattern of the RIS.

The present disclosure also provides an apparatus (e.g., a UE) including a memory storing computer-executable instructions and at least one processor configured to execute the computer-executable instructions to perform the above method, an apparatus including means for performing the above method, and a non-transitory computer-readable medium storing computer-executable instructions for performing the above method.

One innovative aspect of the subject matter described in this disclosure can be implemented in a method of wireless communication at a base station (BS) including: transmitting, to a first UE, a time pattern of a RIS defining activation states of the RIS including at least an off-state and an on-state; determining a state of the UE based at least in part on the time pattern of the RIS and on channel conditions between the base station and the UE when the RIS is in at least the off-state and the on-state; and scheduling communications with the UE when the UE is in an active state

The present disclosure also provides an apparatus (e.g., a BS) including a memory storing computer-executable instructions and at least one processor configured to execute the computer-executable instructions to perform the above method, an apparatus including means for performing the above method, and a non-transitory computer-readable medium storing computer-executable instructions for performing the above method.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communications system and an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 shows a diagram illustrating an example disaggregated base station architecture.

FIG. 5 is a diagram illustrating an example of an environment with a reconfigurable intelligent surface (RIS).

FIG. 6A is a diagram illustrating an example time pattern of a RIS with an off-state and an on-state.

FIG. 6B is a diagram illustrating an example time pattern of a RIS with on-states for different UEs.

FIG. 7 is a diagram illustrating an example of radio conditions in an environment based on a state of the RIS.

FIG. 8 is a diagram illustrating UE states based on an on-state or off-state of the RIS.

FIG. 9 is a diagram illustrating UE states based on a state of the RIS.

FIG. 10 is a message diagram illustrating example messages between a base station and a UE.

FIG. 11 is a conceptual data flow diagram illustrating the data flow between different means/components in an example base station.

FIG. 12 is a conceptual data flow diagram illustrating the data flow between different means/components in an example UE.

FIG. 13 is a flowchart of an example method for a UE to determine a state of the UE based on a state of a RIS.

FIG. 14 is a flowchart of an example method for a base station to schedule a UE for communication during an active state based on a state of a RIS.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In wireless communications, beamforming may be used to compensate for power loss in communication between a transmitter and receiver. For example, in millimeter wave (mmW or mmWave) communications, the frequency may be relatively high compared to conventional communication channels and signal attenuation may be relatively large. However, due to the uncertain nature of a wireless environment and unexpected blocking, a beam may be vulnerable to beam failure. Further, some locations may not have a direct line of sight or other desirable path. For example, a UE may be blocked by buildings or other objects.

One potential technique to address beam blockage in wireless communications is deployment of reconfigurable intelligent surfaces (RIS). A RIS may also be referred to as an intelligent reflecting surface (IRS) or large intelligent surface (LIS). A RIS may be viewed as a type of 2-D antenna array composed of individual scattering elements. The scattering elements may be controlled by a reconfigurable metasurface, which can fully control the phase shifts incurred by individual scattering elements. Because of the simple structure and low cost, proposals for deploying RIS in cellular systems appear to be an attractive technique to improve system performance.

Deployment of a RIS may impact operation of a UE. For example, because a RIS is intended to improve channel conditions between a base station and a UE, the channel conditions may become dependent upon whether a RIS is available to assist a UE. For instance, a RIS may be configured with different states to assist different UEs and states for power saving. In some cases, successful or efficient communications of the UE may be dependent upon a current state of the RIS. For example, a UE may be unable to communicate with a base station when the RIS is in an off-state or is in a state for another UE. In some cases, it may be beneficial for a UE to enter or remain in a low power state based on the state of the RIS.

One mechanism to control a state of the UE is discontinuous reception (DRX). A UE configured with DRX may enter a sleep mode for a certain period of time and wake up for another period of time. While in the sleep mode, the UE does not listen to (e.g., receive and decode) the physical downlink control channel PDCCH, and power saving can be realized. DRX can work in RRC Connected mode and RRC Idle mode, where DRX may be referred to as C-DRX and Idle Mode DRX, respectively. C-DRX has two stages referred to as Short DRX Cycle and Long DRX Cycle. The Short DRX Cycle is optional and may be used to avoid immediate action for the longer sleeping mode of Long DRX Cycle.

One technical problem for deployment of a RIS is the interaction of the RIS state with the state of the UE. In some cases, if the UE is configured with DRX, the on duration of the DRX cycle may not align with an on-state of the RIS. Accordingly, the UE may not be able to receive signals from the base station when the UE is in the on duration.

In an aspect, the present disclosure provides techniques for a UE or a base station to determine a state of the UE based at least in part on a time pattern for a RIS. For example, a UE may obtain a time pattern of a RIS defining activation states of the RIS including at least an off-state and an on-state. The UE may determine a state of the UE based at least in part on the time pattern of the RIS. In some implementations, the UE may measure channel conditions between the UE and the base station when the RIS is in the off-state and the on-state. The state of the UE may also be based at least in part on the channel conditions. For instance, a UE may enter or remain in a low-power state when the channel conditions for the UE when the RIS in in the off-state do not satisfy a threshold. In some implementations, the UE may utilize the time pattern of the RIS to perform beam recovery.

Particular implementations of the subject matter described in this disclosure can be implemented to realize one or more of the following potential advantages. The UE may conserve power by being in a low-power state when the RIS-state does not provide good channel conditions. A base station may more efficiently schedule communications based on the state of the RIS and the state of the UE.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media excludes transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

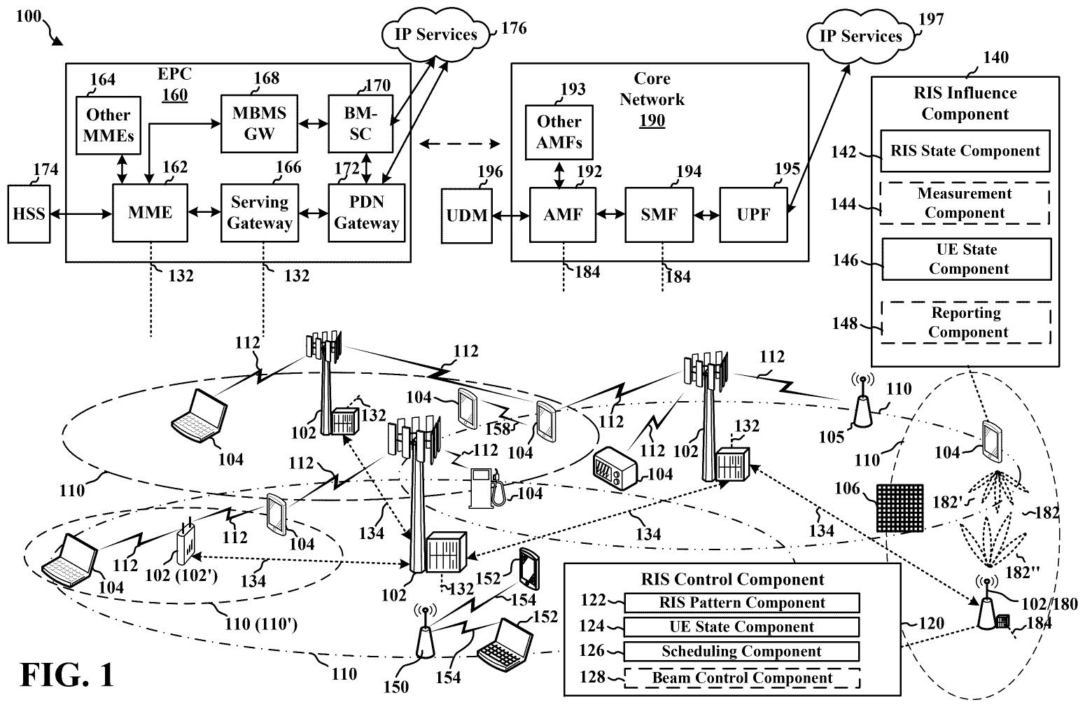

FIG. 1 is a diagram illustrating an example of a wireless communications system and an access network 100. The wireless communications system (also referred to as a wireless wide area network (WWAN)) includes base stations 102, UEs 104, relay devices 105,, RISs 106 an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUS may be implemented within an edge RAN node, and in some aspects, one or more DUs may be co-located with a CU, or may be geographically distributed throughout one or multiple RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU). The base stations 102 may be generically referred to as network entities.

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some implementations, one or more of the UEs 104 may include a RIS influence component 140 configured to report channel characteristics for beam management. The RIS influence component 140 may include a RIS state component 142 configured to obtain a time pattern of a RIS defining activation states of the RIS including at least an off-state and an on-state. In some implementations, the RIS influence component 140 may include a measurement component 144 configured to measure channel conditions between the UE and a base station when the RIS is in at least the off-state and the on-state. The RIS influence component 140 may include a UE state component 146 configured to determine a state of the UE based at least in part on the time pattern of the RIS. In some implementations, the RIS influence component 140 may include a reporting component 148 configured to transmit a report of the state of the UE to the base station.

In some implementations, one or more of the base stations 102 may include a RIS control component 120 configured to schedule communications with a UE based on a state of the RIS and a state of the UE. The RIS control component 120 may include a RIS pattern component 122 configured to transmit, to a first UE, a time pattern of a RIS 106 defining activation states of the RIS including at least an off-state and an on-state. The RIS control component 120 may include a UE state component 124 configured to determine a state of the UE based at least in part on the time pattern of the RIS and on channel conditions between the base station and the UE when the RIS is in at least the off-state and the on-state. The RIS control component 120 may include a scheduling component 126 configured to schedule communications with the UE when the UE is in an active state. In some implementations, the RIS control component 120 may include a beam control component configured to receive a random access channel message on a second beam for the UE when the RIS is in the off-state.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as SI interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

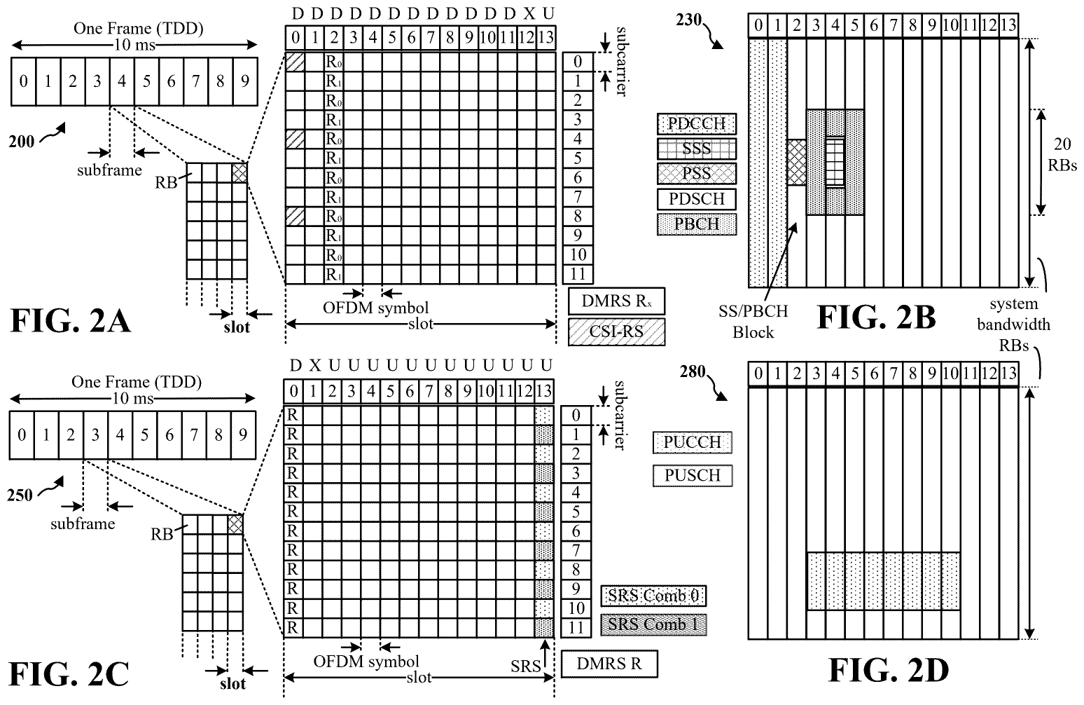

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used.

The UE may transmit sounding reference signals (SRS). An SRS resource set configuration may define resources for SRS transmission. For example, as illustrated, an SRS configuration may specify that SRS may be transmitted in the last symbol of a subframe. The SRS may have a comb structure, and a UE may transmit SRS on one comb for each SRS port. The SRS may be used by a base station for channel quality estimation to enable frequency-dependent scheduling on the UL. The SRS may also be used for channel estimation to select a precoder for downlink MIMO.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

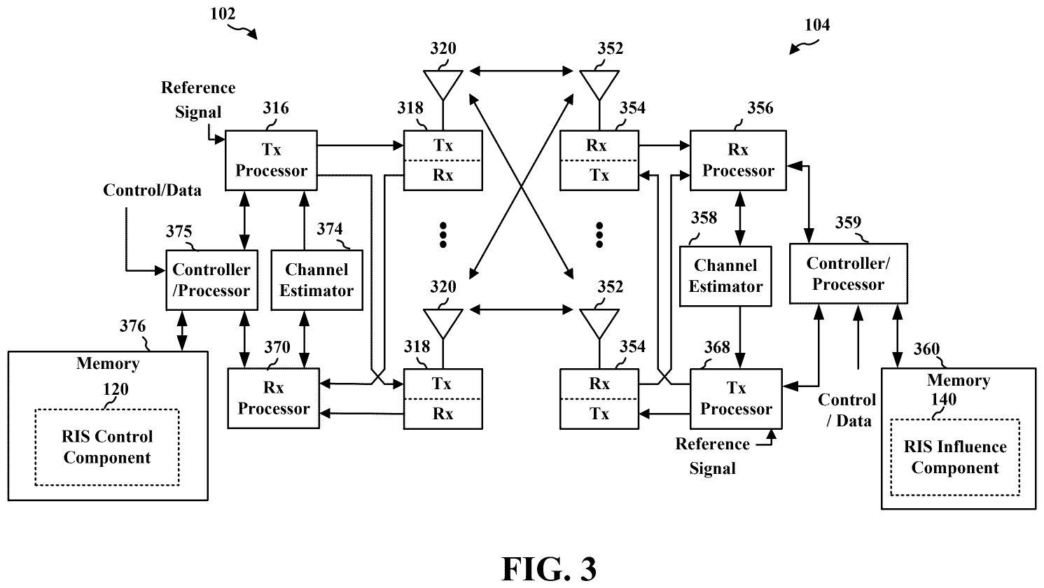

FIG. 3 is a diagram of an example of a base station 102 and a UE 104 in an access network. The UE 104 may be an example of a receiving device. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 104. Each spatial stream may be provided to a different antenna 320 via a separate transmitter 318Tx. Each transmitter 318Tx may modulate an RF carrier with a respective spatial stream for transmission.

At the UE 104, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 104. If multiple spatial streams are destined for the UE 104, they may be combined by the Rx processor 356 into a single OFDM symbol stream. The Rx processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are decoded and deinterleaved to recover the data and control signals that were originally transmitted by the base station 102 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 102, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 102 in a manner similar to that described in connection with the receiver function at the UE 104. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK or NACK protocol to support HARQ operations.

At least one of the Tx processor 368, the Rx processor 356, and the controller/processor 359 may be configured to perform aspects in connection with the RIS influence component 140 of FIG. 1. For example, the memory 360 may include executable instructions defining the RIS influence component 140. The Tx processor 368, the Rx processor 356, and/or the controller/processor 359 may be configured to execute the RIS influence component 140.

At least one of the Tx processor 316, the Rx processor 370, and the controller/processor 375 may be configured to perform aspects in connection with the RIS control component 120 of FIG. 1. For example, the memory 376 may include executable instructions defining the RIS control component 120. The Tx processor 316, the Rx processor 370, and/or the controller/processor 375 may be configured to execute the RIS control component 120.

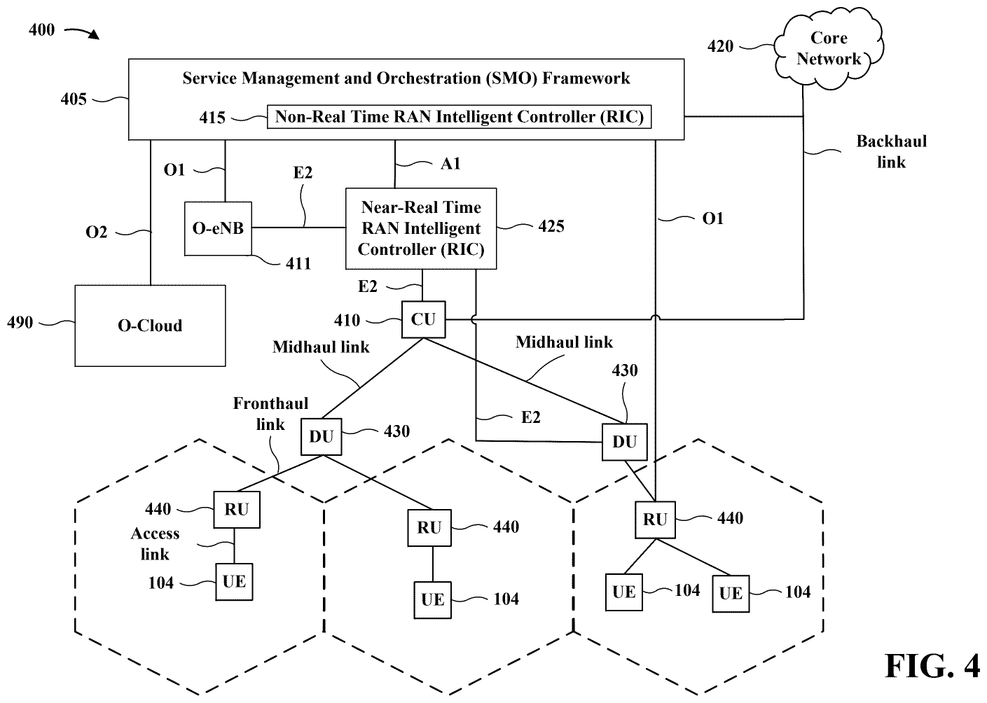

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUS) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

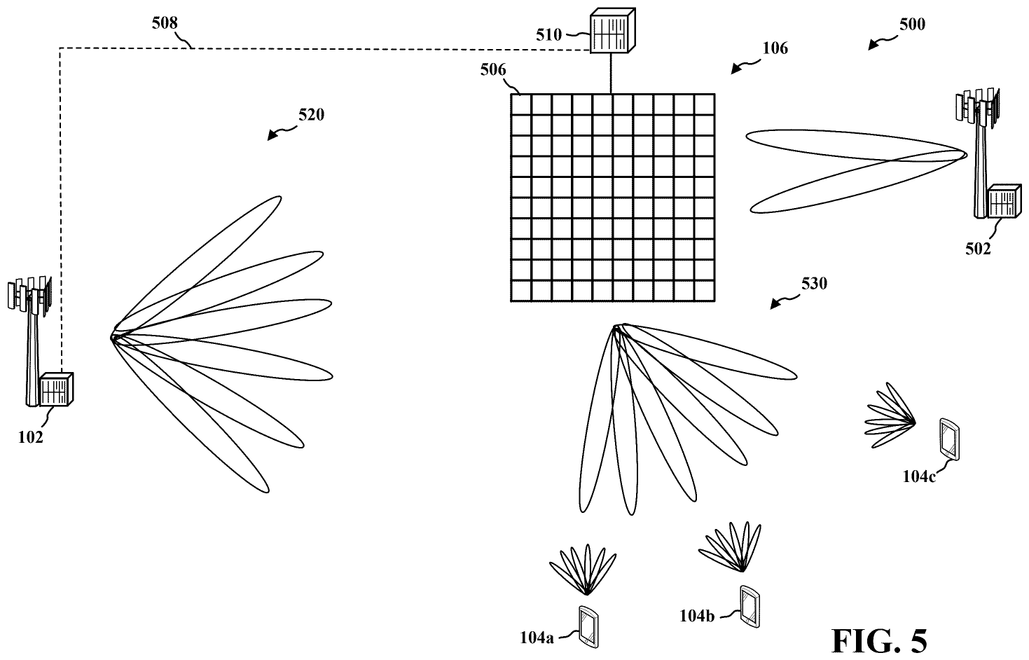

FIG. 5 is a diagram illustrating an example of an environment 500 including a RIS 106. The environment 500 may also include a base station 102 that communicates with a plurality of UEs 104. The base station 102 may use beamforming to transmit on various beams 520. For example, some beams 520 may be directed toward a UE 104 and may provide good channel conditions along a direct path. In some scenarios, the RIS 106 may provide better channel conditions, for example, by providing a path that avoids blockage. The base station 102 may transmit with a beam 520 directed toward the RIS 106, and the RIS 106 may reflect the signal on a beam 530 toward the UE 104. Each of the UEs 104 may also transmit or receive using beamforming. For example, a UE 104 may direct a receive beam toward either the base station 102 or the RIS 106. Similarly, for the uplink, the UE 104 may direct a transmit beam toward the base station 102 or the RIS 106.

The RIS 106 may include a plurality of scattering elements 506. The RIS 106 may be controlled by a RIS controller 510. For example, the RIS controller 510 may generate a metasurface that controls the phase shifts induced by the individual scattering elements 506 to control the beam 530 that is reflected by the RIS 106. The RIS controller 510 may communicate with the base station 102 via a link 508, which may be a wired or wireless backhaul link. In some implementations, the RIS 106 may be dedicated to the base station 102 and may be controlled by the base station 102 via the RIS controller 510. In some implementations, the RIS 106 may be shared with one or more other base stations 502. The RIS controller 510 may attempt to satisfy requests from the base stations 102 and 502, for example, by scheduling a pattern of configurations. In either case, the base station 102 may be informed of the state of the RIS 106 via the link 508.

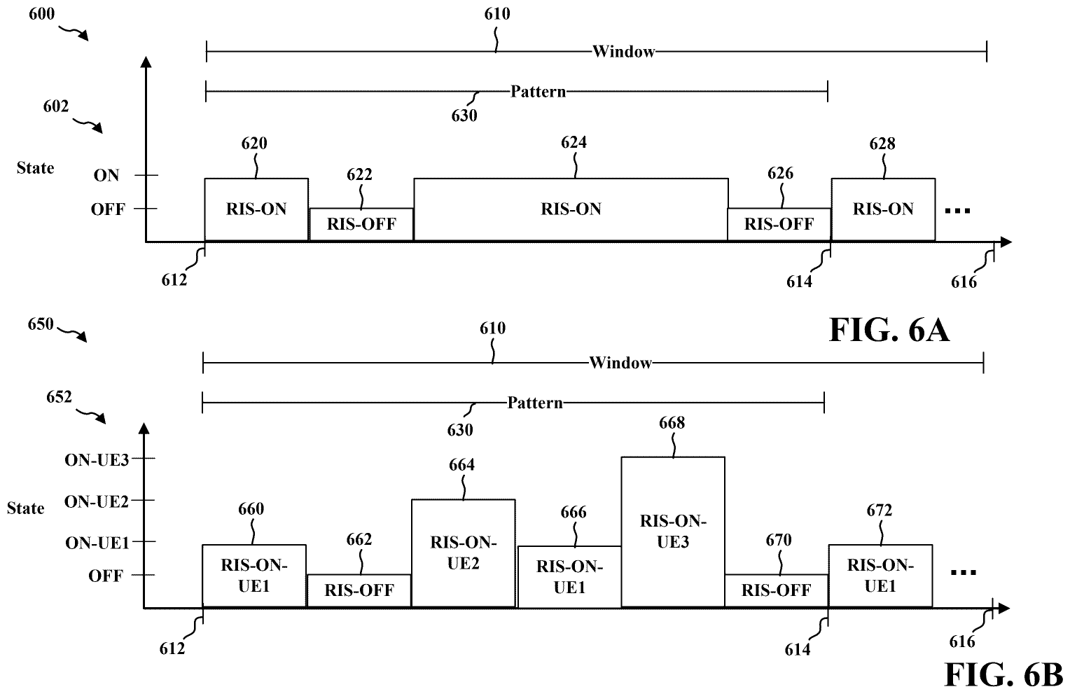

FIG. 6A is a diagram illustrating an example time pattern 600 of a RIS 106 with an off-state and an on-state. The on-state may refer to a state in which the RIS 106 is powered. The RIS 106 may be configured for a UE 104 in the on-state to improve channel conditions for the UE 104. The off-state may refer to a state in which the RIS 106 is not powered. Accordingly, the RIS 106 may not be configured for the UE 104 in the off-state. In some implementations, the RIS controller 510 may be configured with a discontinuous reception (DRX) configuration. For example, the RIS controller 510 may have an on duration where the RIS controller 510 receives configuration information and an off duration where the RIS controller does not receive or update the configuration of the RIS 106. The on duration of the DRX configuration for the RIS controller 510 may be considered an on state, and the off duration of the DRX configuration for the RIS controller 510 may be considered an off-state.

The time pattern 600 may define when the RIS 106 is in the off-state and the on-state. In some implementations, the time pattern 600 may define a repeating pattern of activation states for a time window 610. For example, the time window 610 may start from an indicated slot 612 and end at a slot 616. The time pattern 600 may define periods of one or more states within in the time window 610. For example, the time window 610 may include an on period 620, and off period 622, an on period 624, and off period 626, and an on period 628. In some implementations, the time pattern 600 may follow a repeating pattern 630 (e.g., ending at slot 614). For instance, the repeating pattern 630 may include the periods 620, 622, 624, and 626. The on period 628 may be a repetition of the on period 620, and the repeating pattern 630 may continue until the end of the window 610 at slot 616. In some implementations, the window 610 may be determined dynamically, for example, by an indication of a window start, an indication of a pattern activation, an indication of a window end, or an indication of a pattern deactivation.

FIG. 6B is a diagram illustrating an example time pattern 650 of a RIS 106 with on-states for different UEs. Time pattern 650 may be similar to the time pattern 600 except the on-state may be specific for a UE (e.g., UE 104a, 104b, 104c). For instance, the RIS 106 may select a beam 530 corresponding to the UE. When the base station 102 is serving multiple UEs, the RIS 106 may be configured with an on-state for each UE. During the on-state for a UE, the RIS 106 may be powered on and may select a beam 530 for the UE. Depending on the channel conditions, the beam for one UE may also provide acceptable channel conditions for a second UE. Similar to the time pattern 600, the time pattern 650 may define the state of the RIS 106 for a time window 610 having a start slot 612 and end slot 616. For instance, the window 610 may include an on period 660 for a first UE 104a, an off period 662, an on period 664 for a second UE 104b, an on period 666 for the first UE 104a, an on period 668 for a third UE 104c, an off period 670, and an on period 672 for the first UE 104a. Once again, the window 610 may include a repeating pattern 630.

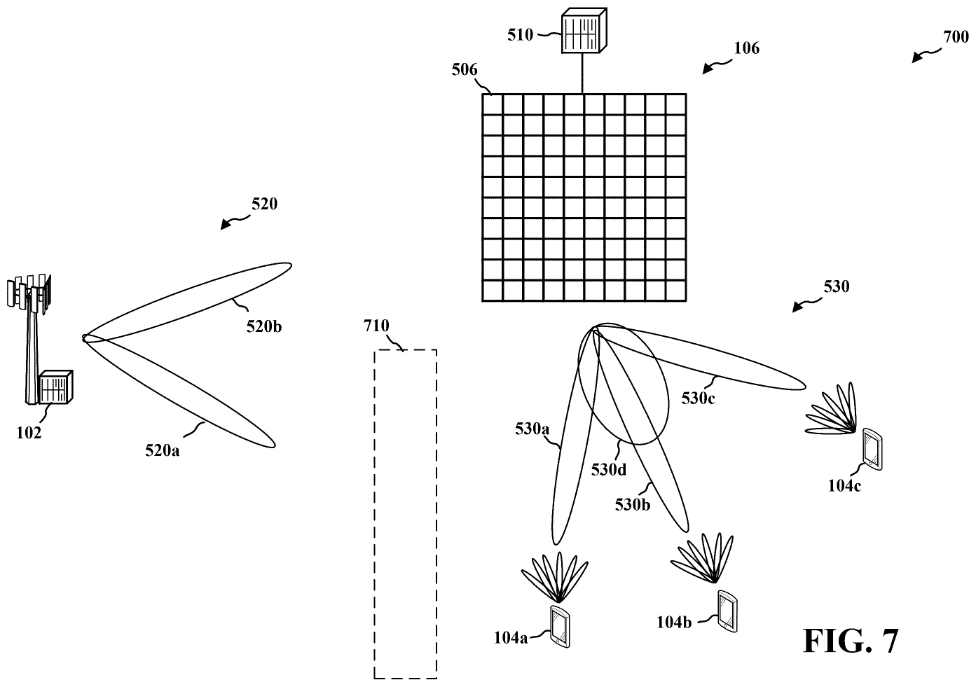

FIG. 7 is a diagram illustrating an example of radio conditions in an environment 700 based on a state of the RIS. The environment 700 may be similar to the environment 500 and include the RIS 106, the base station 102, and UEs 104. In some implementations, there may be a blockage 710 that results in relatively poor channel conditions between the base station 102 and the UEs 104 for a direct path. The RIS 106 may improve channel conditions by reflecting signals toward the UEs on a beam 530, thereby providing an indirect path between the base station 102 and the UEs 104.

In an aspect, when the RIS 106 is in an on-state the base station 102 may select a beam 520b that is directed toward the RIS 106. The RIS 106 may reflect the beam 520b toward one or more UEs 104. For example, each UE 104a, 104b, 104c may correspond to beam 530a, 530b, 530c. In some implementations, the RIS 106 may reflect a wide beam 530d for multiple UEs 104. In some implementations, the UEs 104 may measure channel conditions between the UE 104 and the base station 102 when the RIS 106 is in an on-state. For example, the UE 104 may measure a reference signal received power (RSRP) or signal to interference plus noise ratio (SINR) based on a reference signal such as an SSB or CSI-RS. In some implementations, the base station 102 or the RIS 106 may sweep beams 520 or 530 for the UE 104 to select a best beam. In some implementations, the UE 104 may perform a receive beam sweep to select a best receive beam.

When the RIS 106 is in an off-state, the base station 102 may transmit with a beam 520a that is directed toward the UEs 104. The blockage 710 may result in relatively poor channel conditions. In some implementations, the UE 104 may measure the channel quality between the base station 102 and the UE 104 when the RIS is in the off-state. In some cases, the base station 102 and the UEs 104 may be unable to communicate when the RIS 106 is in the off-state. For example, the UE 104 may measure a channel quality that is below a threshold for beam failure. The UE 104 may be unable to identify another beam and may declare a radio link failure.

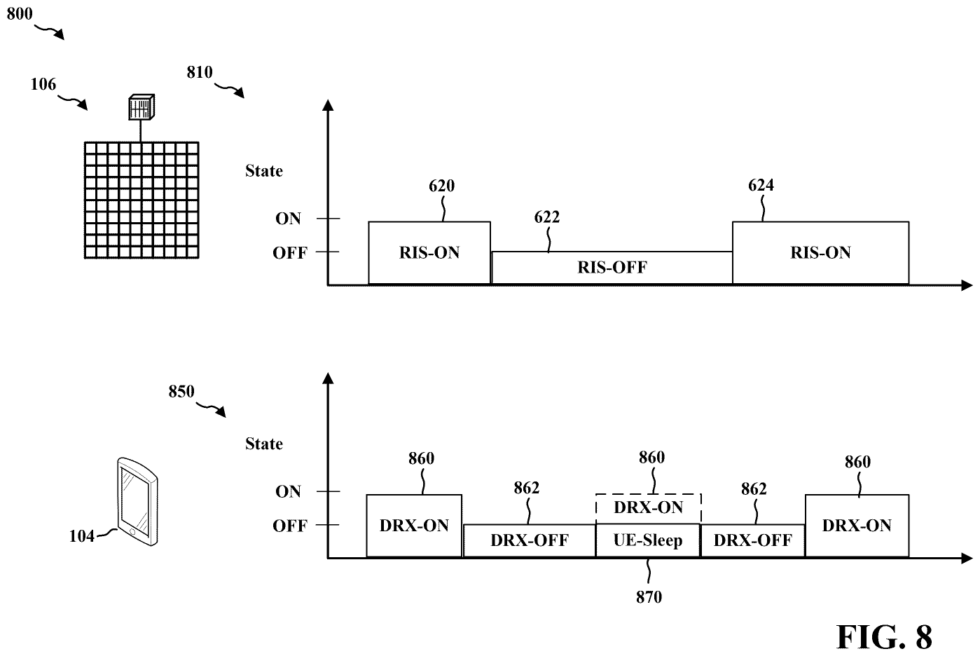

FIG. 8 is a diagram 800 illustrating a state 850 of a UE 104 based a state 810 of the RIS 106. In an aspect, the state 810 of the RIS 106 may follow a pattern 600. For example, the pattern 600 may be configured by the base station 102 or notified to the UE 102 via the link 508. The base station 102 may provide the pattern 600 to the UE 104, for example, as an RRC message or a MAC-CE. Accordingly, the UE 104 may be aware of the state 810 of the RIS 106, at least for the window 610. In some implementations, the UE 104 may assume a default state of the RIS 106 after an end of the window 610 or when no pattern is configured. For example, the default state may be off or on, and may be configured, for example, via RRC configuration.

In an aspect, the state 850 of the UE 104 may be based at least in part on the state of the RIS 106. For example, the UE 104 may be configured with a DRX configuration including a DRX on duration 860 and a DRX off duration 862 that repeat in a cycle. When the DRX on duration 860 occurs while the state 850 of the RIS is in an off period 622, the channel quality between the base station 102 and the UE 104 may be degraded. In some implementations, the UE 104 may be configured to enter or remain in a sleep state 870 whenever the RIS 106 is in an off-state. For example, the sleep state 870 may be similar to the to the DRX off-state in which the UE 104 does not monitor PDCCH. Accordingly, the UE 104 may save power when the RIS state does not facilitate communication with the base station 102. In some implementations, the UE 104 may transmit a report to the base station 102 indicating whether the UE 104 remains in the sleep state 870 during an off period 622. Accordingly, the base station 102 may avoid scheduling the UE 104 when the UE 104 is in the sleep state 870.

In some implementations, the state 850 of the UE 104 may be based at least in part on channel conditions measured by the UE. For example, the UE 104 may measure channel conditions between the UE 104 and the base station 102 when the RIS is in at least the off-state and the on-state. The UE 104 may determine whether to enter or remain in an inactive state (e.g., sleep state 870) when the RIS is in the off-state based on whether the channel condition of the UE when the RIS is in the off-state satisfies a threshold. For example, if the RSRS or SINR measured by the UE is less than the threshold, the UE 104 may enter or remain in the sleep state 870 during the DRX on duration 860 that overlaps with the off period 622 for the RIS 106. In some implementations, the base station 102 may determine whether the UE 104 should be in the sleep state 870. For example, the UE 104 may report the channel conditions to the base station 102, and the base station 102 may transmit an indication of the state of the UE for a time period (e.g., corresponding to the off period 622 of the RIS 106).

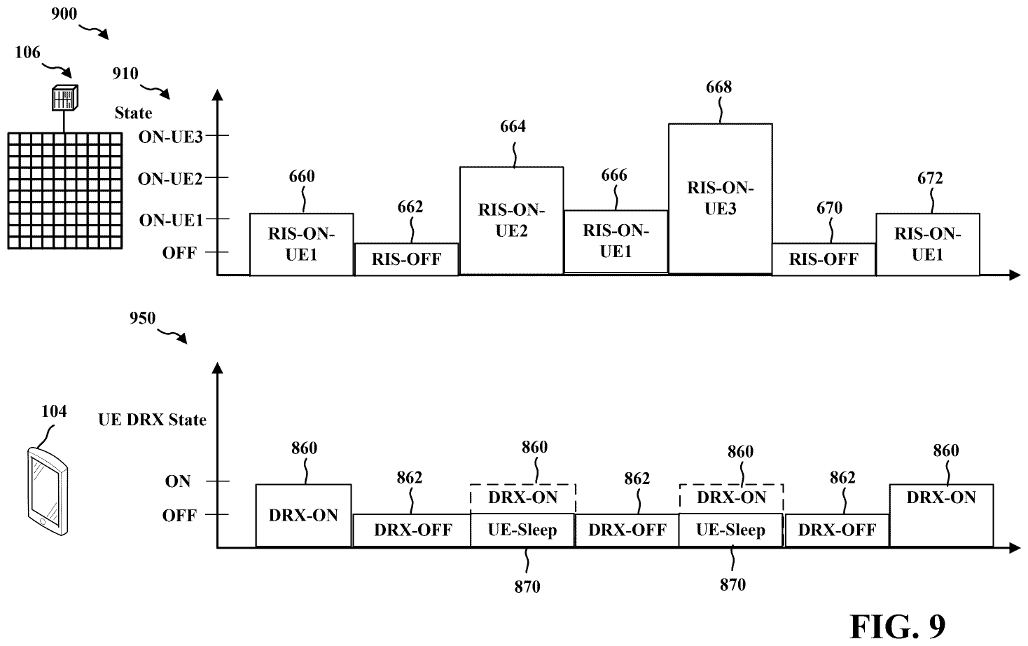

FIG. 9 is a diagram illustrating a diagram 900 illustrating a state 950 of a UE 104 based on different on-states 910 of the RIS 106. In an aspect, the state 910 of the RIS 106 may follow the pattern 650. Similar to FIG. 8, for example, the pattern 650 may be configured by the base station 102 or notified to the UE 102 via the link 508. The base station 102 may provide the pattern 650 to the UE 104, for example, as an RRC message or a MAC-CE. Accordingly, the UE 104 may be aware of the state 910 of the RIS 106, at least for the window 610. The UE 104 may be configured with a DRX configuration similar to that discussed above regarding FIG. 8.

In an aspect, when the RIS 106 follows a pattern 650 that includes on-states for different UEs, the state of the UE 104 may be based at least in part on which on-state the RIS 106 is in. For example, for the first UE 104a, the UE 104a may enter or remain in an active state when the RIS 106 is in an on-state for the UE 104a. For instance, the first UE 104a may be in an active state when the DRX on duration 860 occurs during the on period 660 for the first UE 104a. As another example, when the RIS 106 is in the on period 664 for the second UE 104b, the first UE 104b may be configured with a DRX on duration 860. The UE 104 may determine whether to enter or remain in the sleep state 870. In some implementations, the UE 104 may enter the sleep state 870 when the RIS state is an on period for a different UE. In some implementations, the UE 104 may determine whether to enter an active state based on channel conditions when the RIS is in the active state for the other UE. For example, as illustrated in FIG. 7, the first UE 104a may be relatively close the second UE 104b such that the beam 530b may cover the UE 104a, for example, with a sidelobe. Accordingly, the UE 104a may experience sufficiently good channel conditions to communicate with the base station 102 during the on period 664 for the second UE 104b. Therefore, the UE 104a may determine to enter or remain in an active state during the on duration 860 that occurs during the on period 664 for the second UE 104b. In contrast, as illustrated in FIG. 7, the first UE 104a may be relatively far from the third UE 104c. When the RIS 106 is in the on period 668 for the third UE 104c and using the beam 530c, the UE 104a may experience relatively poor channel conditions such that the UE 104a cannot communicate with the base station 102. Therefore, the UE 104a may enter or remain in the sleep state 870 during the on duration 860 that occurs during the on period 668.

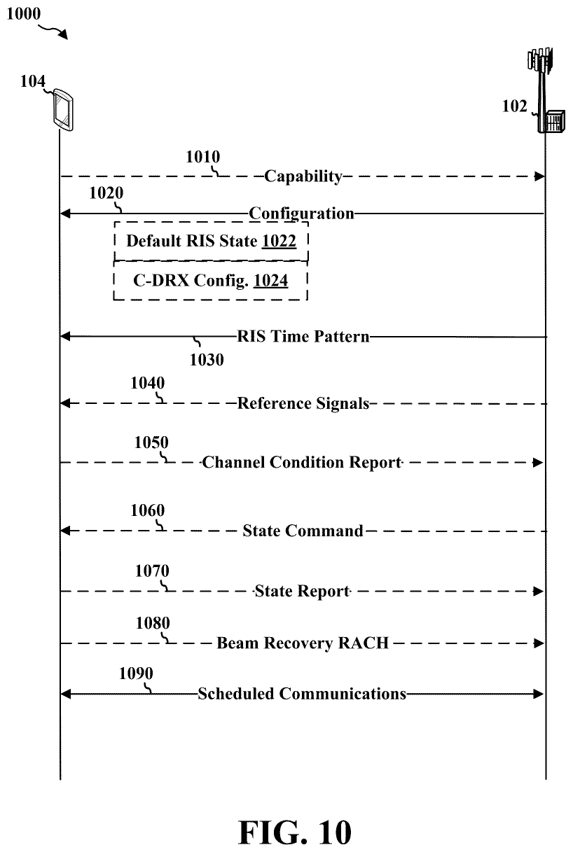

FIG. 10 is a message diagram 1000 illustrating example messages between a base station 102 and a UE 104. The UE 104 may be an example of a UE 104 including the RIS influence component 140. The base station 102 may include the RIS control component 120.

In some implementations, the UE 104 may optionally transmit a capability message 1010 to the base station 102. For example, the capability message 1010 may be a RRC message. The capability message 1010 may indicate, for example, that the UE 104 is capable of determining a state of the UE based on a state of a RIS.

The base station 102 may transmit a configuration 1020. The configuration 1020 may be, for example, an RRC message. For example, the configuration 1020 may include a default RIS state 1022 and/or a C-DRX configuration 1024. For instance, the C-DRX configuration 1024 may specify the DRX on duration 860 and the DRX off duration 862.

The base station 102 may transmit a RIS time pattern 1030. The RIS time pattern 1030 may indicate the state of the RIS 106 for a period of time. For example, the RIS time pattern 1030 may be similar to the example time patterns 600 or 650. The RIS time pattern 1030 may include a start slot 612, end slot 616, window 610, and/or repeating pattern 630. The RIS time pattern 1030 may be, for example, an RRC message or a MAC-CE.

The base station 102 may optionally transmit reference signals 1040. For example, the reference signals 1040 may include SSBs and/or CSI-RS. The UE 104 may measure channel conditions based on the reference signals 1040. For example, the UE 104 may measure channel conditions when the RIS 106 is in the off-state and when the RIS 106 is in any of the on-states. In some implementations, the UE 104 may determine different channel conditions for each on-state of the RIS 106.

The UE 104 may transmit a channel condition report 1050. The channel condition report 1050 may indicate the channel conditions for one or more states of the RIS 106. For example, the channel condition report 1050 may include reference signal measurements for when the RIS is in the off-state and when the RIS is in the on-state; a difference between reference signal measurements for when the RIS is in the off-state and when the RIS is in the on-state; a recommended state of the UE; and/or a duration of the recommended state of the UE.

In some implementations, the base station 102 may optionally transmit a state command 1060 in response to the channel condition report 1050. The state command 1060 may indicate what state the UE should be in for a period of time. For example, the state command 1060 may indicate whether the UE 104 should enter the sleep state 870 during a DRX on duration. In some implementations, the state command 1060 may define a rule for the UE 104 to follow regarding the state. For example, the state command 1060 may indicate that the UE 104 should enter the sleep state 870 when the RIS is in an off-state, or the state command 1060 may indicate that the UE 104 should be in an active state when the RIS is in one or more on-states.

In some implementations, the UE 104 may transmit a state report 1070. The state report 1070 may indicate a state of the UE 104. In some implementations, the state report 1070 may indicate a duration of the state of the UE 104. In some implementations, the state report 1070 may indicate the state of the UE 104 under various conditions. For example, the state report 1070 may indicate whether the UE remains inactive when the C-DRX on period begins during the off-state or any of the on-states of the RIS.

In some implementations, the UE 104 may perform a beam recovery procedure to switch to a second beam when the RIS 106 is in the off-state. For example, the UE 104 may transmit a beam recovery RACH 1080 after the RIS 106 switches to the off-state. The beam recovery RACH 1080 may, for example, indicate that the beam 520a is the best beam when the RIS 106 is off. In some implementations, the RIS time pattern 1030 or the state command 1060 may indicate when the UE 104 should perform the beam recovery procedure (e.g., with respect to the state of the RIS 106).

The base station 102 and the UE 104 may transmit and receive scheduled communications 1090. The scheduled communications 1090 may include, for example, downlink transmission on the PDSCH or uplink transmissions on the PUSCH. The scheduled communications 1090 may also include scheduling such as a downlink control information (DCI) or an RRC message and MAC-CE for semi-persistent scheduling or configured grants. The base station 102 may schedule the scheduled communications 1090 for periods when the UE is in an active state.

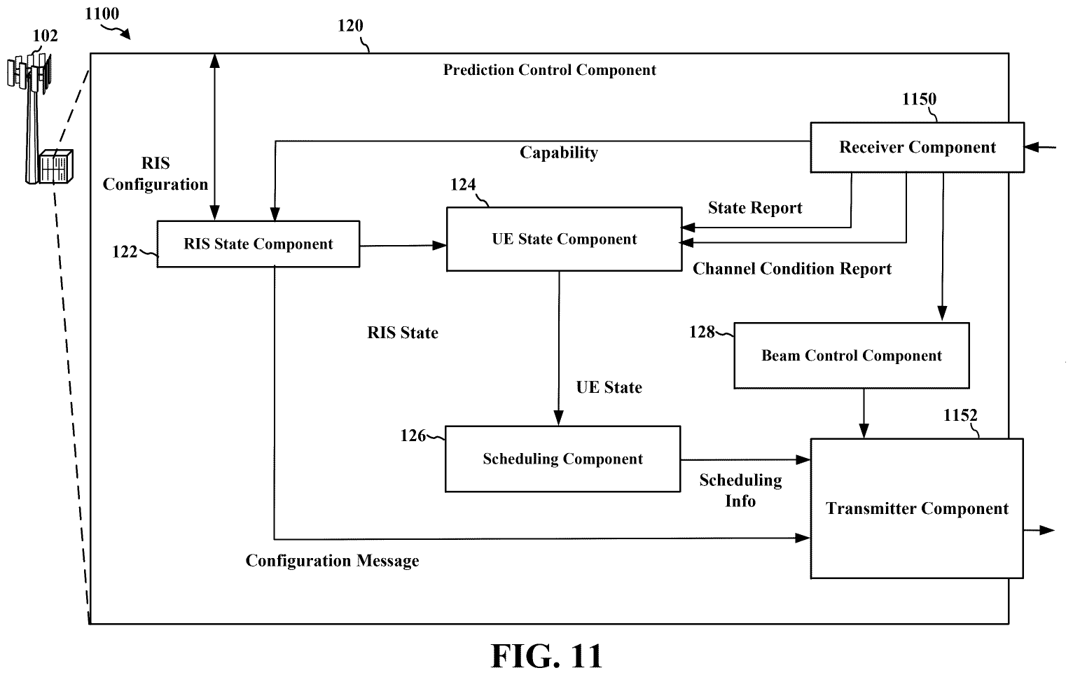

FIG. 11 is a conceptual data flow diagram 1100 illustrating the data flow between different means/components in an example base station 102, which may be an example of the base station 102 including the RIS control component 120. The RIS control component 120 may be implemented by the memory 376 and the Tx processor 316, the Rx processor 370, and/or the controller/processor 375 of FIG. 3. For example, the memory 376 may store executable instructions defining the RIS control component 120 and the Tx processor 316, the Rx processor 370, and/or the controller/processor 375 may execute the instructions.

The base station 102 may include a receiver component 1150, which may include, for example, a radio frequency (RF) receiver for receiving the signals described herein. The base station 102 may include a transmitter component 1152, which may include, for example, an RF transmitter for transmitting the signals described herein. In an aspect, the receiver component 1150 and the transmitter component 1152 may co-located in a transceiver such as illustrated by the Tx/Rx 318 in FIG. 3.

As discussed with respect to FIG. 1, the RIS control component 120 may include the RIS pattern component 122, the UE state component 124, and the scheduling component 126. In some implementations, the RIS control component 120 may include the beam control component 128.

The receiver component 1150 may receive UL signals from the UE 104 including the capability message 1010, channel condition report 1050, or the state report 1070. The receiver component 1150 may provide the capability message 1010 to the RIS pattern component 122. The receiver component 1150 may provide the channel condition report 1050 and/or the state report 1070 to the UE state component 124.

The RIS pattern component 122 may be configured to output, for transmission to a first UE, a time pattern of a RIS defining activation states of the RIS including at least an off-state and an on-state. The RIS pattern component 122 may obtain the capability message 1010 from the first UE via the receiver component 1270. The RIS pattern component 122 may obtain a configuration of the RIS 106 via the link 508 with the RIS controller 510. In some implementations, the RIS pattern component 122 may configure or request that the RIS 106 be in an on-state. For example, the RIS pattern component 122 may configure or request that the RIS provide an on-state during an on duration for a UE. The RIS controller 510 may not be able to accommodate all requests, and the RIS configuration may indicate the configured or scheduled state of the RIS 106. The RIS pattern component 122 may determine a time pattern of the RIS based on the RIS configuration. For example, the RIS pattern component 122 may forecast the state of the RIS for a future time period (e.g., window 610). The RIS pattern component 122 may output the time pattern for transmission to the UE 104 via the transmitter component 1152. The RIS pattern component 122 may output a current RIS state to the UE state component 124.

The UE state component 124 may be configured to determine a state of the UE based at least in part on the time pattern of the RIS and on channel conditions between the base station and the UE when the RIS is in at least the off-state and the on-state. In some implementations, the UE state component 124 may obtain a state report 1070 from the UE 104 via the receiver component 1150. The UE state component 124 may In some implementations, the UE state component 124 may receive the channel condition report 1050 via the receiver component 1150. The state report 1070 may indicate the state of the UE under various conditions (e.g., RIS state or channel conditions). The UE state component 124 may evaluate the conditions to determine the state of the UE. The UE state component 124 may output the state of the UE 104 to the scheduling component 126.

The scheduling component 126 may be configured to schedule communications with the UE when the UE is in an active state. The scheduling component 126 may obtain the state of the UE 104 from the UE state component 124. The scheduling component 126 may receive data for transmission from higher layers or a scheduling request from the UE 104 via the receiver component 1150. The scheduling component 126 may identify resources for a transmission during a period when the UE 104 is in an active state. The scheduling component 126 may output scheduling information for transmission via the transmitter component 1152 to schedule the scheduled communications 1090.

The beam control component 128 may be configured to receive the beam recovery RACH 1080 on a secondary beam via the receiver component 1150. In some implementations, the beam control component 128 may output an indication for the UE 104 to transmit the beam recovery RACH 1080 prior to the RIS 106 entering the off-state. The indication may specify a time after the RIS 106 enters the off-state for the UE 104 to transmit the beam recovery RACH 1080. In some implementations, the beam control component 128 may expect the beam recovery RACH 1080 after the RIS 106 enters the off-state without transmitting an indication. The beam control component 128 may configure the transmitter component 1152 to use the second beam in response to the beam recovery RACH 1080.

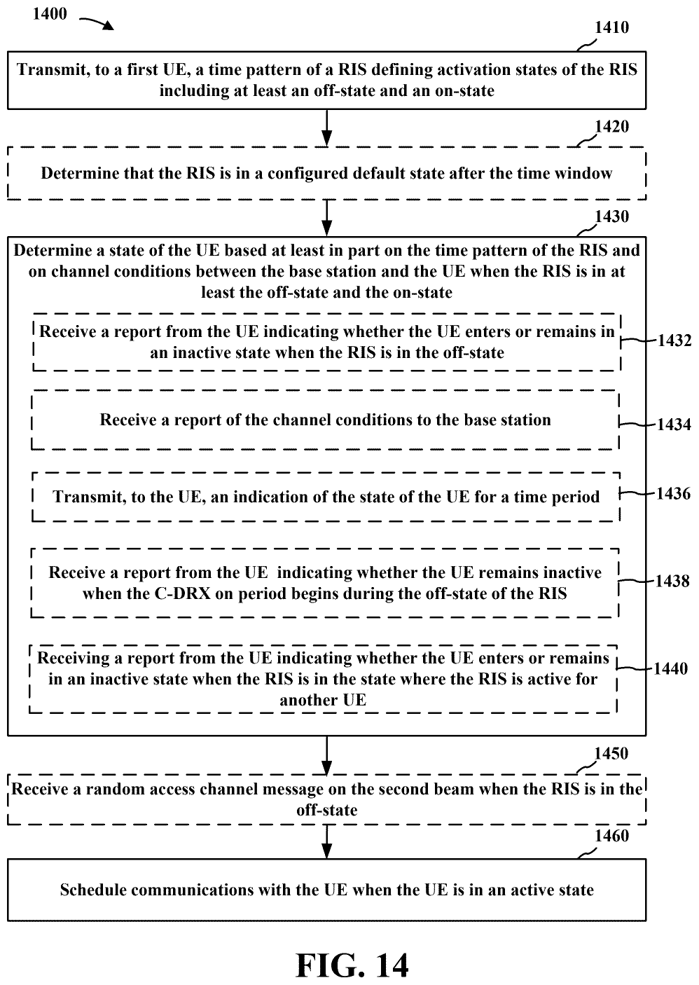

Various components of base station 102 may provide means for performing the methods described herein, including with respect to FIG. 14. In some examples, means for transmitting, outputting, or sending (or means for outputting for transmission) may include the transceivers 318TX and/or antenna(s) 320 of the base station 102 illustrated in FIG. 3 and/or the transmitter component 1152 of the base station 102 in FIG. 11. Means for configuring, indicating, obtaining, selecting, and updating may include the controller/processor 375, memory 376, and other various processors of FIG. 3 and/or the various components of FIG. 11 discussed above.

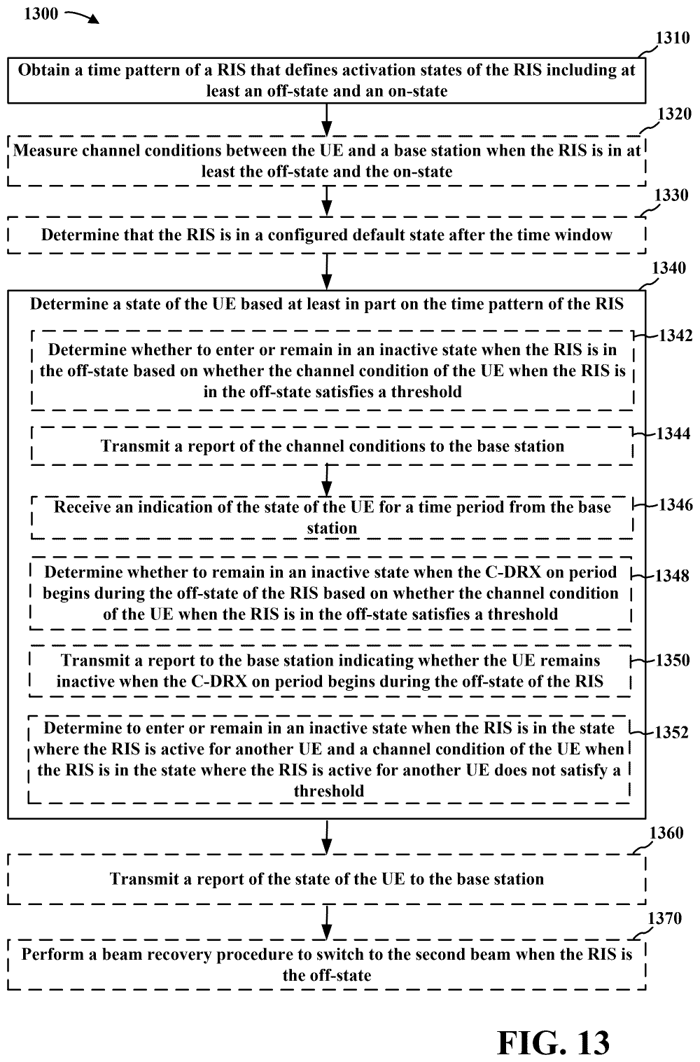

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 13 is an example, and many other examples and configurations of the base station 102 are possible.

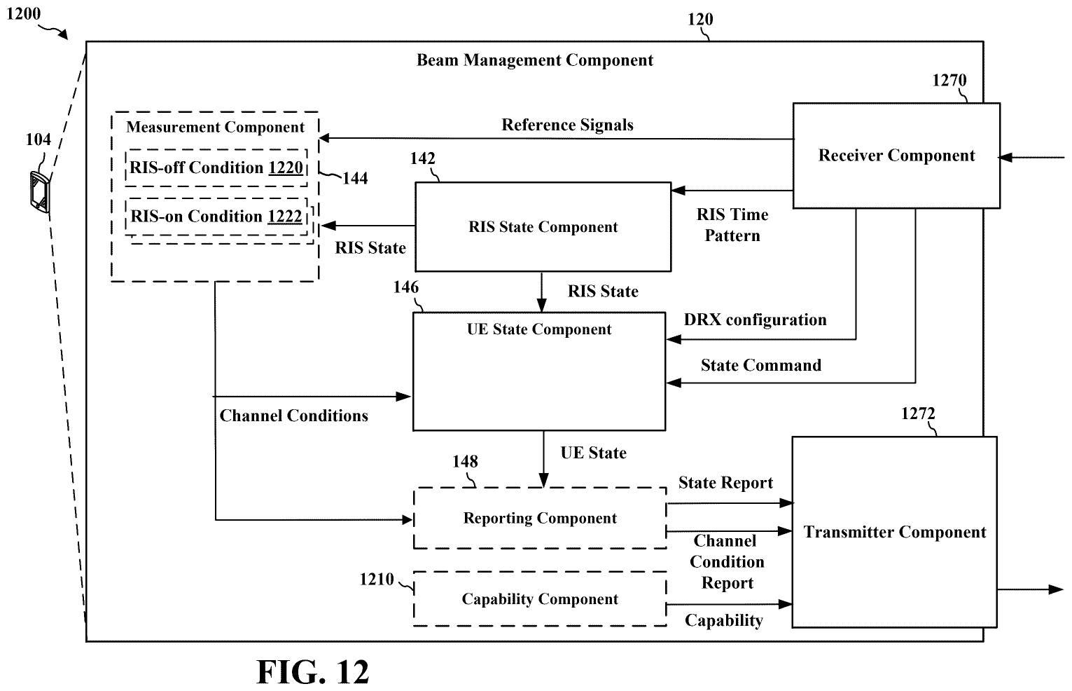

FIG. 12 is a conceptual data flow diagram 1200 illustrating the data flow between different means/components in an example UE 104, which may include the RIS influence component 140. The RIS influence component 140 may be implemented by the memory 360 and the Tx processor 368, the Rx processor 356, and/or the controller/processor 359. For example, the memory 360 may store executable instructions defining the RIS influence component 140 and the Tx processor 368, the Rx processor 356, and/or the controller/processor 359 may execute the instructions.

The UE 104 may include a receiver component 1270, which may include, for example, a RF receiver for receiving the signals described herein. The UE 104 may include a transmitter component 1272, which may include, for example, an RF transmitter for transmitting the signals described herein. In an aspect, the receiver component 1270 and the transmitter component 1272 may co-located in a transceiver such as the Tx/Rx 352 in FIG. 3.

As discussed with respect to FIG. 1, the RIS influence component 140 may include the RIS state component 142 and the UE state component 146. In some implementations, the RIS influence component 140 may optionally include the measurement component 144, the reporting component 148, and/or a capability component 1210.

The receiver component 1270 may receive DL signals described herein such as the configuration 1020, the RIS time pattern 1030, the reference signals 1040, or the state command 1060. The receiver component 1270 may provide the configuration 1020 to the UE state component 146. The receiver component 1270 may provide the RIS time pattern 1030 to the RIS pattern component 122. The receiver component 1270 may provide the reference signals 1040 to the measurement component 144. The receiver component 1270 may provide the state command 1060 to the UE state component 146.

In some implementations, the capability component 1210 may be configured to output for transmission an indication of a capability of the UE to determine a state of the UE based on a state of a RIS 106. For example, the capability component 1210 may output an RRC capability message 1010 for transmission via the transmitter component 1272.

The RIS state component 142 may be configured to obtain a time pattern of a RIS defining activation states of the RIS including at least an off-state and an on-state. For example, the RIS state component 142 may obtain the RIS time pattern 1030 from the base station 102 via the receiver component 1270. For instance, the RIS time pattern 1030 may be transmitted as an RRC configuration message or a MAC-Ce. The RIS state component 142 may decode the RIS time pattern 1030 to determine a time pattern 600 or 650 for the RIS 106 and the individual time periods when the RIS 106 is in each state. The RIS state component 142 may output the RIS state to the measurement component 144 and/or the UE state component 146.

The measurement component 144 may be configured to measure channel conditions between the UE and a base station when the RIS is in at least the off-state and the on-state. The measurement component 144 may obtain reference signals or measurements thereof from the receiver component 1270. The measurement component 144 may determine a RIS-off condition 1220 and/or a RIS-on condition 1222 based on the reference signals. In some implementations, the measurement component 144 may determine a RIS-on condition 1222 for each on-state of the RIS 106 corresponding to a different UE. The measurement component 144 may output the channel conditions to the UE state component 146 and/or the reporting component 148.

The UE state component 146 may be configured to determine a state of the UE based at least in part on the time pattern of the RIS. The UE state component 146 may obtain the time pattern of the RIS from the RIS pattern component 122. The UE state component 146 may obtain a DRX configuration and/or a state command from the base station 102 via the receiver component 1270. The UE state component 146 may obtain channel conditions from the measurement component 144. In some implementations, the UE state component 146 may determine the state of the UE based on a rule. For example, the rule may indicate that the UE enters or remains in an inactive state whenever the RIS 106 is in an off-state. As another example, the rule may be based on the state of the RIS and the channel conditions. For example, the UE may enter or remain in an inactive state when the RIS is in the off-state and the RIS-off condition 1220 does not satisfy a threshold. In some implementations, the UE state component 146 may determine the UE state based on the state command 1060 received from the base station. For example, the state command 1060 may specify the rule for determining the state or may specify a state of the UE for a particular time period. The UE state component 146 may output the state of the UE to the reporting component 148.

The reporting component 148 may be configured to transmit a report of the state of the UE or a report of the channel conditions to the base station. The reporting component 148 may obtain the state of the UE from the UE state component 146. The reporting component 148 may obtain the channel conditions from the measurement component 144. The reporting component 148 may generate the state report 1070, for example, as uplink control information (UCI) or a MAC-CE. The reporting component 148 may output the state report 1070 for transmission via the transmitter component 1272. The reporting component 148 may generate the channel condition report 1050 as UCI. For example, a channel state information (CSI) report may be extended to include measurements for each state of the RIS 106. The reporting component 148 may output the channel condition report 1050 for transmission via the transmitter component 1272.

Various components of base station 102 may provide means for performing the methods described herein, including with respect to FIG. 13. In some examples, means for transmitting, outputting, or sending (or means for outputting for transmission) may include the transceivers 354TX and/or antenna(s) 352 of the UE 104 illustrated in FIG. 3 and/or the transmitter component 1272 of the UE 104 in FIG. 12. Means for measuring, generating, reporting, obtaining, selecting, and updating may include the controller/processor 359, memory 360, and other various processors of FIG. 3 and/or the various components of FIG. 12 discussed above.

In some cases, rather than actually transmitting, for example, signals and/or data, a device may have an interface to output signals and/or data for transmission (a means for outputting). For example, a processor may output signals and/or data, via a bus interface, to an RF front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 3. Notably, FIG. 12 is an example, and many other examples and configurations of the UE 104 are possible.

FIG. 13 is a flowchart of an example method 1300 for a UE 104 to determine a state of the UE based on a state of a RIS 106. The method 1300 may be performed by a UE 104 (such as the UE 104, which may include the memory 360 and which may be the entire UE 104 or a component of the UE 104 such as the RIS influence component 140, Tx processor 368, the Rx processor 356, or the controller/processor 359). The method 1300 may be performed by the RIS influence component 140 in communication with the RIS control component 120 of the base station 102. Optional blocks are shown with dashed lines.

At block 1310, the method 1300 includes obtaining a time pattern of a RIS that defines activation states of the RIS including at least an off-state and an on-state. In some implementations, for example, the UE 104, the Rx processor 356 or the controller/processor 359 may execute the RIS influence component 140 or the RIS state component 142 to obtain a time pattern (e.g., RIS time pattern 1030) of a RIS 106 that defines activation states 602, 652 of the RIS 106 including at least an off-state and an on-state. For example, the RIS time pattern 1030 may indicate the time pattern 600 or 650, which may define a repeating pattern 630 of the activation states during a time window 610 starting from an indicated slot 612. Accordingly, the UE 104, the Rx processor 356, or the controller/processor 359 executing the RIS influence component 140 or the RIS state component 142 may provide means for obtaining a time pattern of a RIS that defines activation states of the RIS including at least an off-state and an on-state.

At block 1320, the method 1300 may optionally include measuring channel conditions between the UE and a base station when the RIS is in at least the off-state and the on-state. In some implementations, for example, the UE 104, the Rx processor 356 or the controller/processor 359 may execute the RIS influence component 140 or the measurement component 144 to measure channel conditions between the UE and a base station when the RIS is in at least the off-state and the on-state. Accordingly, the UE 104, the Rx processor 356, or the controller/processor 359 executing the RIS influence component 140 or the measurement component 144 may provide means for measuring channel conditions between the UE and a base station when the RIS is in at least the off-state and the on-state.

At block 1330, the method 1300 may optionally include determining that the RIS is in a configured default state after the time window. In some implementations, for example, the UE 104, the Rx processor 356 or the controller/processor 359 may execute the RIS influence component 140 or the RIS state component 142 to determine that the RIS is in a configured default RIS state 1022 after the time window 610. Accordingly, the UE 104, the Rx processor 356, or the controller/processor 359 executing the RIS influence component 140 or the RIS state component 142 may provide means for determining that the RIS is in a configured default state after the time window.

At block 1340, the method 1300 includes determining a state of the UE based at least in part on the time pattern of the RIS. In some implementations, for example, the UE 104, the Rx processor 356, the Tx processor 368, or the controller/processor 359 may execute the RIS influence component 140 or the UE state component 146 to determine the state of the UE based at least in part on the time pattern of the RIS. In some implementations, at sub-block 1342, the block 1340 may optionally include determining whether to enter or remain in an inactive state when the RIS is in the off-state based on whether the channel condition of the UE when the RIS is in the off-state satisfies a threshold.

In some implementations, at sub-block 1344, the block 1340 may optionally include transmitting a report of the channel conditions (e.g., channel condition report 1050) to the base station 102. For example, the report of the channel conditions may include one or more of: reference signal measurements for when the RIS is in the off-state and when the RIS is in the on-state; a difference between reference signal measurements for when the RIS is in the off-state and when the RIS is in the on-state; a recommended state of the UE; or a duration of the recommended state of the UE. In some implementations, at sub-block 1346, the block 1340 may optionally include receiving an indication of the state of the UE (e.g., UE state command 1060) for a time period from the base station. The sub-block 1346 may be in response to the report transmitted in sub-block 1344.

In some implementations, the UE is configured with a C-DRX configuration 1024. Determining the state of the UE may be for at least a portion of a C-DRX on period. In some implementations, the state of the UE remains inactive when the C-DRX on period begins during the off-state of the RIS. In such implementations, at sub-block 1348, the block 1340 may optionally include determining whether to remain in an inactive state when the C-DRX on period begins during the off-state of the RIS based on whether the channel condition of the UE when the RIS is in the off-state satisfies a threshold. In some implementations, at sub-block 1350, the block 1340 may optionally include transmitting a report to the base station indicating whether the UE remains inactive when the C-DRX on period begins during the off-state of the RIS.

In some implementations, the activation states of the RIS further include a state where the RIS is active for another UE. For example, the state where the RIS is active for another UE may be within a time period for the on-state in the time pattern of the RIS. In such implementations, at sub-block 1352, the block 1340 may optionally include determining to enter or remain in an inactive state when the RIS is in the state where the RIS is active for another UE and a channel condition of the UE when the RIS is in the state where the RIS is active for another UE does not satisfy a threshold. The block 1340 may further include transmitting a report to the base station indicating whether the UE remains inactive when the RIS is in the state where the RIS is active for another UE. In view of the foregoing, the UE 104, the Rx processor 356, the Tx processor 368, or the controller/processor 359 executing the RIS influence component 140 or the RIS state component 142 may provide means for determining a state of the UE based at least in part on the time pattern of the RIS.

At block 1360, the method 1300 may optionally include transmitting a report of the state of the UE to the base station. In some implementations, for example, the UE 104, the Tx processor 368 or the controller/processor 359 may execute the RIS influence component 140 or the reporting component 148 to transmit a report of the state of the UE to the base station. Accordingly, the UE 104, the Tx processor 368, or the controller/processor 359 executing the RIS influence component 140 or the reporting component 148 may provide means for transmitting a report of the state of the UE to the base station.

In some implementations, the channel conditions between the UE and the base station when the RIS is the on-state is associated with a first beam and the channel conditions between the UE and the base station when the RIS is in the off-state is associated with a second beam. At block 1370, the method 1300 may optionally include performing a beam recovery procedure to switch to the second beam when the RIS is the off-state. In some implementations, for example, the UE 104, the Tx processor 368 or the controller/processor 359 may execute the RIS influence component 140 or the reporting component 148 to perform a beam recovery procedure to switch to the second beam when the RIS is the off-state. Accordingly, the UE 104, the Tx processor 368, or the controller/processor 359 executing the RIS influence component 140 or the reporting component 148 may provide means for performing a beam recovery procedure to switch to the second beam when the RIS is the off-state.

FIG. 14 is a flowchart of an example method 1400 for a base station to determine a state of a UE based on a state of an RIS. The method 1400 may be performed by a base station (such as the base station 102, which may include the memory 376 and which may be the entire base station 102 or a component of the base station 102 such as the RIS control component 120, the Tx processor 316, the Rx processor 370, or the controller/processor 375). The method 1400 may be performed by the RIS control component 120 in communication with the RIS influence component 140 of the UE 104.

At block 1410, the method 1400 includes transmitting, to a first UE, a time pattern of a RIS that defines activation states of the RIS including at least an off-state and an on-state. In some implementations, for example, the base station 102, the Tx processor 316, or the controller/processor 375 may execute the RIS control component 120 or the RIS pattern component 122 to transmit, to a first UE, a time pattern of a RIS that defines activation states of the RIS including at least an off-state and an on-state. In some implementations, the time pattern defines a repeating pattern of the activation states during a time window starting from an indicated slot. Accordingly, the base station 102, the Tx processor 316, or the controller/processor 375 executing the RIS control component 120 or the RIS pattern component 122 may provide means for transmitting, to a first UE, a time pattern of a RIS that defines activation states of the RIS including at least an off-state and an on-state.

At block 1420, the method 1400 may optionally include determining that the RIS is in a configured default state after the time window. In some implementations, for example, the base station 102, the Rx processor 370, or the controller/processor 375 may execute the RIS control component 120 or the RIS pattern component 122 to determine that the RIS is in a configured default state after the time window. Accordingly, the base station 102, the Rx processor 370, or the controller/processor 375 executing the RIS control component 120 or the RIS pattern component 122 may provide means for determining that the RIS is in a configured default state after the time window.

At block 1430, the method 1400 includes determining a state of the UE based at least in part on the time pattern of the RIS and on channel conditions between the base station and the UE when the RIS is in at least the off-state and the on-state. In some implementations, for example, the base station 102, the Rx processor 370, the Tx processor 316, or the controller/processor 375 may execute the RIS control component 120 or the UE state component 124 to determine a state of the UE based at least in part on the time pattern of the RIS and on channel conditions between the base station and the UE when the RIS is in at least the off-state and the on-state.

In some implementations, at sub-block 1432, the block 1430 may optionally include receiving a report from the UE indicating whether the UE enters or remains in an inactive state when the RIS is in the off-state.

In some implementations, at sub-block 1434, the block 1430 may optionally include receiving a report of the channel conditions to the base station. The report of the channel conditions may include one or more of: reference signal measurements for when the RIS is in the off-state and when the RIS is in the on-state; a difference between reference signal measurements for when the RIS is in the off-state and when the RIS is in the on-state; a recommended state of the UE; or a duration of the recommended state of the UE.

In some implementations, at sub-block 1436, the block 1430 may optionally include transmitting, to the UE, an indication of the state of the UE for a time period.

In some implementations, the UE is configured with a C-DRX configuration. In such implementations, determining the state of the UE is for at least a portion of a C-DRX on period. In some implementations, the state of the UE remains inactive when the C-DRX on period begins during the off-state of the RIS. At sub-block 1438, the block 1430 may optionally include receiving a report from the UE indicating whether the UE remains inactive when the C-DRX on period begins during the off-state of the RIS.

In some implementations, the activation states of the RIS further include a state where the RIS is active for another UE. At sub-block 1440, the block 1430 may optionally include receiving a report from the UE indicating whether the UE enters or remains in an inactive state when the RIS is in the state where the RIS is active for another UE.

In view of the foregoing, the base station 102, Rx processor 370, the Tx processor 316, or the controller/processor 375 executing the RIS control component 120 or the UE state component 124 may provide means for determining a state of the UE based at least in part on the time pattern of the RIS and on channel conditions between the base station and the UE when the RIS is in at least the off-state and the on-state.

In some implementations, the channel conditions between the UE and the base station when the RIS is the on-state is associated with a first beam and the channel conditions between the UE and the base station when the RIS is in the off-state is associated with a second beam. At block 1450, the method 1400 may optionally include receiving a random access channel message on the second beam when the RIS is in the off-state. In some implementations, for example, the base station 102, the Rx processor 370, or the controller/processor 375 may execute the RIS control component 120 or the beam control component 128 to receive a random access channel message on the second beam when the RIS is in the off-state. Accordingly, the base station 102, the Rx processor 370, or the controller/processor 375 executing the RIS control component 120 or the beam control component 128 may provide means for receiving a random access channel message on the second beam when the RIS is in the off-state.

At block 1460, the method 1400 includes scheduling communications with the UE when the UE is in an active state. In some implementations, for example, the base station 102, the Rx processor 370, or the controller/processor 375 may execute the RIS control component 120 or the scheduling component 126 to schedule communications with the UE when the UE is in an active state. Accordingly, the base station 102, the Rx processor 370, or the controller/processor 375 executing the RIS control component 120 or the scheduling component 126 may provide means for scheduling communications with the UE when the UE is in an active state.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

### EXAMPLE ASPECTS

1. A method of wireless communication at a user equipment (UE), comprising:
   obtaining a time pattern of a reconfigurable intelligent surface (RIS) that defines activation states of the RIS including at least an off-state and an on-state; and
   determining a state of the UE based at least in part on the time pattern of the RIS.
2. The method of clause 1, wherein the time pattern defines a repeating pattern of the activation states during a time window starting from an indicated slot.
3. The method of clause 2, further comprising determining that the RIS is in a configured default state after the time window.
4. The method of any of clauses 1-3, wherein the activation states of the RIS further include a state where the RIS is active for another UE.
5. The method of clause 4, wherein the state where the RIS is active for another UE is within a time period for the on-state in the time pattern of the RIS.
6. The method of clause 4 or 5, wherein determining the state of the UE comprises determining to enter or remain in an inactive state when the RIS is in the state where the RIS is active for another UE and a channel condition of the UE when the RIS is in the state where the RIS is active for another UE does not satisfy a threshold.
7. The method of clause 4 or 5, wherein determining the state of the UE comprises transmitting a report to a base station indicating whether the UE remains inactive when the RIS is in the state where the RIS is active for another UE.
8. The method of any of clauses 1-7, further comprising measuring channel conditions between the UE and a base station when the RIS is in at least the off-state and the on-state, wherein determining the state of the UE is based at least in part on the channel conditions.
9. The method of clause 8, wherein determining the state of the UE comprises determining whether to enter or remain in an inactive state when the RIS is in the off-state based on whether the channel condition of the UE when the RIS is in the off-state satisfies a threshold.
10. The method of clause 9, further comprising, transmitting a report of the state of the UE to the base station.
11. The method of clause 10, wherein the report includes a duration of the state of the UE.
12. The method of clause 8, wherein determining the state of the UE comprises:
   transmitting a report of the channel conditions to the base station; and
   receiving an indication of the state of the UE for a time period from the base station.
13. The method of clause 12, wherein the report of the channel conditions includes one or more of:
   reference signal measurements for when the RIS is in the off-state and when the RIS is in the on-state;
   a difference between reference signal measurements for when the RIS is in the off-state and when the RIS is in the on-state;
   a recommended state of the UE; or
   a duration of the recommended state of the UE.
14. The method of any of clauses 8-13, wherein the UE is configured with a connected mode discontinuous reception (DRX) configuration, wherein determining the state of the UE is for at least a portion of a C-DRX on period.
15. The method of clause 14, wherein the state of the UE remains inactive when the C-DRX on period begins during the off-state of the RIS.
16. The method of clause 14, wherein determining the state of the UE comprises determining whether to remain in an inactive state when the C-DRX on period begins during the off-state of the RIS based on whether the channel condition of the UE when the RIS is in the off-state satisfies a threshold.
17. The method of clause 14, wherein determining the state of the UE comprises transmitting a report to the base station indicating whether the UE remains inactive when the C-DRX on period begins during the off-state of the RIS.
18. The method of any of clauses 8-17, wherein the channel conditions between the UE and the base station when the RIS is the on-state is associated with a first beam and the channel conditions between the UE and the base station when the RIS is in the off-state is associated with a second beam.
19. The method of clause 18, further comprising performing a beam recovery procedure to switch to the second beam when the RIS is the off-state.
20. A method of wireless communication at a base station, comprising: transmitting, to a first user equipment (UE), a time pattern of a reconfigurable intelligent surface (RIS) defining activation states of the RIS including at least an off-state and an on-state;
   determining a state of the UE based at least in part on the time pattern of the RIS and on channel conditions between the base station and the UE when the RIS is in at least the off-state and the on-state; and
   scheduling communications with the UE when the UE is in an active state.
21. The method of clause 20, wherein the time pattern defines a repeating pattern of the activation states during a time window starting from an indicated slot.
22. The method of clause 21, further comprising determining that the RIS is in a configured default state after the time window.
23. The method of any of clauses 20-22, wherein determining the state of the UE comprises receiving a report from the UE indicating whether the UE enters or remains in an inactive state when the RIS is in the off-state.
24. The method of clause 23, wherein the report includes a duration of the state of the UE.
25. The method of any of clauses 20-24, wherein determining the state of the UE comprises:
   receiving a report of the channel conditions to the base station; and
   transmitting, to the UE, an indication of the state of the UE for a time period.
26. The method of clause 25, wherein the report of the channel conditions includes one or more of:
   reference signal measurements for when the RIS is in the off-state and when the RIS is in the on-state;
   a difference between reference signal measurements for when the RIS is in the off-state and when the RIS is in the on-state;
   a recommended state of the UE; or
   a duration of the recommended state of the UE.
27. The method of any of clauses 20-26, wherein the UE is configured with a connected mode discontinuous reception (C-DRX) configuration, wherein determining the state of the UE is for at least a portion of a C-DRX on period.
28. The method of clause 27, wherein the state of the UE remains inactive when the C-DRX on period begins during the off-state of the RIS.
29. The method of clause 27, wherein determining the state of the UE comprises receiving a report from the UE indicating whether the UE remains inactive when the C-DRX on period begins during the off-state of the RIS.
30. The method of any of clauses 20-29, wherein the activation states of the RIS further include a state where the RIS is active for another UE.
31. The method of clause 30, wherein the state where the RIS is active for another UE is within a time period for the on-state in the time pattern of the RIS.
32. The method of clause 30, wherein determining the state of the UE comprises receiving a report from the UE indicating whether the UE enters or remains in an inactive state when the RIS is in the state where the RIS is active for another UE
33. The method of any of clauses 20-32, wherein the channel conditions between the UE and the base station when the RIS is the on-state is associated with a first beam and the channel conditions between the UE and the base station when the RIS is in the off-state is associated with a second beam.
34. The method of clause 33, further comprising receiving a random access channel message on the second beam when the RIS is in the off-state.
35. An apparatus for wireless communication, comprising: a memory storing computer-executable instructions; and a processor configured to execute the instructions and cause the apparatus to perform the method of any of clauses 1-19.
36. An apparatus for wireless communication, comprising: a memory storing computer-executable instructions; and a processor configured to execute the instructions and cause the apparatus to perform the method of any of clauses 20-34.
37. A user equipment (UE), comprising: a transceiver; a memory storing computer-executable instructions; and a processor configured to execute the instructions and cause the UE to perform the method of any of clauses 1-19.
38. A base station, comprising: a transceiver; a memory storing computer-executable instructions; and a processor configured to execute the instructions and cause the base station to perform the method of any of clauses 20-34.
39. An apparatus for wireless communications, comprising means for performing a method in accordance with any one of clauses 1-19.
40. An apparatus for wireless communications, comprising means for performing a method in accordance with any one of clauses 20-34.

41. A non-transitory computer-readable medium comprising instructions that, when executed by an apparatus, causes the apparatus to perform a method in accordance with any one of clauses 1-19.
42. A non-transitory computer-readable medium comprising instructions that, when executed by an apparatus, cause the apparatus to perform a method in accordance with any one of clauses 20-34.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication at a user equipment (UE), comprising:
obtaining a time pattern of a reconfigurable intelligent surface (RIS) that defines activation states of the RIS including at least an off-state and an on-state; and
determining a state of the UE based at least in part on the time pattern of the RIS.

2. (canceled)

3. (canceled)

4. (canceled)

5. (canceled)

6. The method of claim 1, wherein determining the state of the UE comprises determining to enter or remain in an inactive state when the RIS is in the state where the RIS is active for another UE and a channel condition of the UE when the RIS is in the state where the RIS is active for another UE does not satisfy a threshold.

7. The method of claim 1, further comprising measuring channel conditions between the UE and a base station when the RIS is in at least the off-state and the on-state, wherein determining the state of the UE is based at least in part on the channel conditions.

8. The method of claim 7, wherein determining the state of the UE comprises determining whether to enter or remain in an inactive state when the RIS is in the off-state based on whether the channel condition of the UE when the RIS is in the off-state satisfies a threshold.

9. (canceled)

10. The method of claim 7, wherein determining the state of the UE comprises:
transmitting a report of the channel conditions to the base station; and
receiving an indication of the state of the UE for a time period from the base station.

11. The method of claim 10, wherein the report of the channel conditions includes one or more of:
reference signal measurements for when the RIS is in the off-state and when the RIS is in the on-state;
a difference between reference signal measurements for when the RIS is in the off-state and when the RIS is in the on-state;
a recommended state of the UE; or
a duration of the recommended state of the UE.

12. The method of claim 7, wherein the UE is configured with a connected mode discontinuous reception (DRX) configuration, wherein determining the state of the UE is for at least a portion of a C-DRX on period.

13. The method of claim 12, wherein the state of the UE remains inactive when the C-DRX on period begins during the off-state of the RIS.

14. The method of claim 12, wherein determining the state of the UE comprises determining whether to remain in an inactive state when the C-DRX on period begins during the off-state of the RIS based on whether the channel condition of the UE when the RIS is in the off-state satisfies a threshold.

15. The method of claim 12, wherein determining the state of the UE comprises transmitting a report to the base station indicating whether the UE remains inactive when the C-DRX on period begins during the off-state of the RIS.

16. The method of claim 7, wherein the channel conditions between the UE and the base station when the RIS is the on-state is associated with a first beam and the channel conditions between the UE and the base station when the RIS is in the off-state is associated with a second beam.

17. The method of claim 16, further comprising performing a beam recovery procedure to switch to the second beam when the RIS is the off-state.

18. A method of wireless communication at a base station, comprising:
transmitting, to a first user equipment (UE), a time pattern of a reconfigurable intelligent surface (RIS) defining activation states of the RIS including at least an off-state and an on-state;
determining a state of the UE based at least in part on the time pattern of the RIS and on channel conditions between the base station and the UE when the RIS is in at least the off-state and the on-state; and
scheduling communications with the UE when the UE is in an active state.

19. (canceled)

20. (canceled)

21. The method of claim 18, wherein determining the state of the UE comprises:
receiving a report of the channel conditions to the base station; and
transmitting, to the UE, an indication of the state of the UE for a time period.

22. (canceled)

23. The method of claim 18, wherein the UE is configured with a connected mode discontinuous reception (C-DRX) configuration, wherein determining the state of the UE is for at least a portion of a C-DRX on period.

24. The method of claim 23, wherein the state of the UE remains inactive when the C-DRX on period begins during the off-state of the RIS.

25. The method of claim 24, wherein determining the state of the UE comprises receiving a report from the UE indicating whether the UE remains inactive when the C-DRX on period begins during the off-state of the RIS.

26. (canceled)

27. The method of claim 18, wherein the channel conditions between the UE and the base station when the RIS is the on-state is associated with a first beam and the channel conditions between the UE and the base station when the RIS is in the off-state is associated with a second beam.

28. The method of claim 27, further comprising receiving a random access channel message on the second beam when the RIS is in the off-state.

29. An apparatus for wireless communication at a user equipment (UE), comprising:
a transceiver;
a memory storing computer-executable instructions; and
a processor coupled with the transceiver and the memory and configured to:
obtain, via the transceiver, a time pattern of a reconfigurable intelligent surface (RIS) that defines activation states of the RIS including at least an off-state and an on-state; and
determine a state of the UE based at least in part on the time pattern of the RIS.

30. (canceled)
